(19) United States
(12) Patent Application Publication
(10) Pub. No.: US 2007/0155392 A1
(43) Pub. Date: Jul. 5, 2007

(54) Method and apparatus for allocating channel quality information channel in a wireless communication system

(75) Inventors: Min-Hee Cho, Suwon-si (KR); Hee-Kwun Cho, Incheon (KR); Hyeong-Jong Ju, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., Ltd., Suwon-si (KR)

(21) Appl. No.: 11/649,183

(22) Filed: Jan. 3, 2007

(30) Foreign Application Priority Data
Jan. 3, 2006 (KR) 2006-0000369

(51) Int. Cl. H04Q 7/20

(52) U.S. Cl. 455/450

(57) ABSTRACT

A method and apparatus for dynamically allocating and releasing a Channel Quality Information CHannel (CQICH) to and from a Mobile Station (MS) in a Base Station (BS) communicating with a plurality of MSs on a common radio channel in a wireless communication system are provided, in which the BS determines whether the MS is under a first group, when a CQICH is to be allocated to the MS, determines whether any data transmission has occurred for a CQICH allocation period preset for the first group and counted from a reallocation time, if the MS is under the first group, and groups the MS to a second group and reallocates a CQICH to the MS, the second group having a lower priority level than the first group, if no data transmission has occurred for the CQICH allocation period.

### PRIORITY

This application claims the benefit under 35 U.S.C. § 119(a) of a Korean Patent Application filed in the Korean Intellectual Property Office on Jan. 3, 2006 and assigned Ser. No. 2006-369, the contents of which are incorporated herein by reference.

### BACKGROUND OF THE INVENTION

1. Field of the Invention

The present invention relates generally to a method and apparatus for dynamically allocating and releasing a Channel Quality Information Channel (CQICH) to and from a Mobile Station (MS) by a Base Station (BS) in a wireless communication system where the BS communicates with a plurality of MSs on a common channel.

2. Description of the Related Art

A BS communicates with a plurality of MSs on a common radio channel and sends a data packet received over a wired network to a particular MS on the common radio channel. Due to the use of the common radio channel in communicating with the MSs, the BS should adopt different modulation and coding schemes for the MSs according to their reception channel statuses to increase the efficiency of the communication system.

To learn the channel statuses of the MSs, the BS should receive feedback Channel Quality Information (CQI) from the MSs. For this purpose, the BS allocates CQICHs for carrying the CQI to the MSs.

Conventionally, when an MS is connected to the BS, the BS allocates a CQICH to the MS. The CQICH is released only when the MS releases the connection from the BS or transitions to a sleep mode or idle mode. This conventional CQICH allocation method makes it difficult for many MSs to report their CQI on a limited number of CQICHs.

In this context, a dynamic CQICH allocation method and apparatus are required in which the BS dynamically allocates CQICHs by estimating the presence or absence of transmission data (traffic) for the MSs. That is, there is a need for a method and apparatus for dynamically allocating and releasing a limited number of CQICHs to and from MSs so that they can efficiently report CQI of the common radio channel.

Also, there is a need for a method and apparatus for maximizing the number of MSs that can report their radio channel statuses to the BS in the wireless communication network.

There is a further need for a method and apparatus for dynamically allocating and releasing CQICHs to and from MSs so that the BS can receive reports of accurate CQI from the MSs when receiving data from the MSs simultaneously on the common radio channel.

### SUMMARY OF THE INVENTION

An object of the present invention is to address at least the problems and/or disadvantages and to provide at least the advantages described below. Accordingly, an object of the present invention is to provide a method and apparatus for dynamically allocating and releasing a limited number of CQICHs to and from a plurality of MSs by a BS, so that the MSs can efficiently feed back their CQIs of a common radio channel to the BS on the CQICHs.

An object of the present invention is to provide a method and apparatus for maximizing the number of MSs that feed back their radio channel statuses to a BS in a wireless communication network.

An object of the present invention is to provide a method and apparatus for dynamically allocating and releasing CQICHs to and from a plurality of MSs, so that a BS can receive accurate feedback CQIs when receiving data simultaneously from the MSs on a common radio channel.

According to the present invention, there is provided a CQICH allocation method in a wireless communication system, in which it is determined whether the MS is under a first group, when a CQICH is to be allocated to the MS, and whether any data transmission has occurred for a CQICH allocation period preset for the first group, counted from a reallocation time, if the MS is under the first group, and the MS is grouped to a second group having a lower priority level than the first group and reallocated a CQICH, if no data transmission has occurred for the CQICH allocation period.

### BRIEF DESCRIPTION OF THE DRAWINGS

The above and other objects, features and advantages of certain preferred embodiments of the present invention will be more apparent from the following detailed description taken in conjunction with the accompanying drawings, in which:

FIG. 1 illustrates a wireless communication system in which a BS allocates CQICHs to MSs according to the present invention;

FIG. 2 illustrates a process of allocating a CQICH to an MS and releasing the CQICH from the MS by the BS on a time axis according to the present invention;

FIG. 3 is a flowchart illustrating a CQICH management operation for reallocating or releasing a CQICH to or from an MS when the remaining CQICH allocation period of the MS is 0 according to the present invention;

FIG. 4 is a flowchart illustrating an operation for allocating a CQICH to a new MS according to the present invention; and

FIG. 5 is a block diagram of the BS in the wireless communication system illustrated in FIG. 1.

### DETAILED DESCRIPTION OF THE PREFERRED EMBODIMENTS

The matters defined in the description such as a detailed construction and elements are provided to assist in a comprehensive understanding of preferred embodiments of the invention. Accordingly, those of ordinary skill in the art will recognize that various changes and modifications of the embodiments described herein can be made without departing from the scope and spirit of the invention. Descriptions of well-known functions and constructions are omitted herein for the sake of clarity and conciseness.

The present invention provides a method and apparatus for dynamically allocating CQICHs to a plurality of MSs by a BS that communicates with the MSs on a common radio channel in a wireless communication system.

To improve data transmission efficiency by selecting optimal modulation and coding schemes for data transmission to a plurality of MSs, the BS should know the statuses of the common radio channel between the BS and the MSs. That is, when the BS decides to send data to an MS, it has to know the status of the common radio channel between the BS and the MS.

The BS cannot allocate an infinite number of CQICHs to MSs. Due to limited available CQICH capacity, the BS does not have full knowledge of the channel statuses of all MSs under coverage of the BS. Thus, the BS should efficiently allocate and release CQICHs to the MSs. For example, if the BS receives CQIs regarding the common radio channel in the absence of any data to be sent to the MSs and receives no CQIs in the presence of any data to be sent to the MSs, the CQICH allocation is inefficient, leading to a wasted CQICH. Accordingly, the present invention provides a method for dynamically allocating and releasing CQICHs such that the BS can acquire accurate CQIs for use in data transmission to MSs.

In accordance with the present invention, for CQICH management, MSs to which CQICHs are to be allocated are separated into n groups. An MS with a high probability of receiving data from the BS is ranked high and thus has priority in occupying a CQICH. Typically, the BS allocates a CQICH to an MS when sending data to the MS. Simultaneously, the BS sets a CQICH allocation period and a CQI report interval for the MS. The MS then reports its CQI to the BS during the CQICH allocation period. When the CQICH allocation period expires, the CQICH is automatically released from the MS.

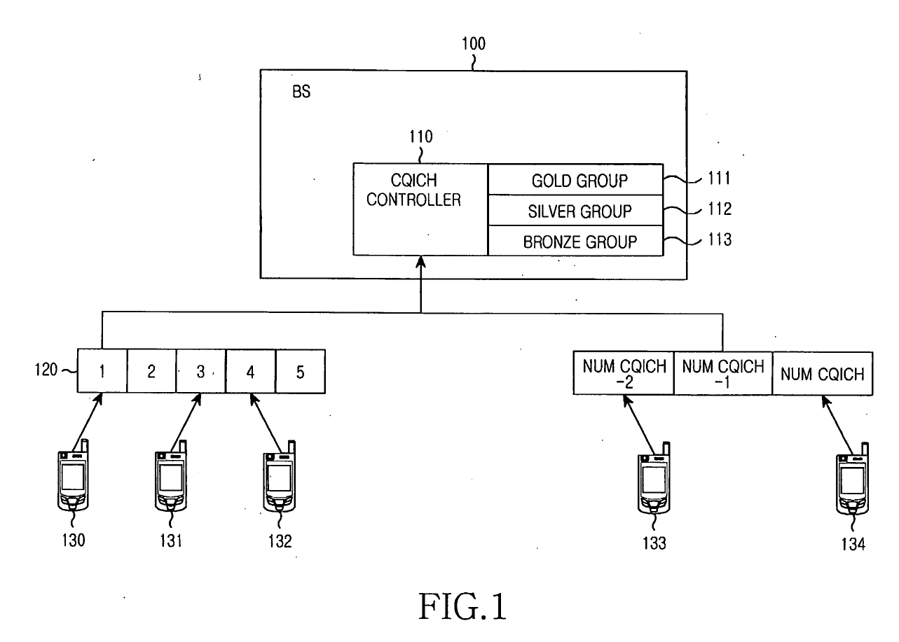

FIG. 1 illustrates a wireless communication system in which a BS allocates CQICHs to MSs according to the present invention. The BS separates MSs into n groups, for dynamic CIQCH allocation. For example, the BS defines three MS groups (Gold, Silver and Bronze) in the wireless communication system illustrated in FIG. 1.

Referring to FIG. 1, the BS allocates CQICHs to MSs 130 to 134. The MSs 130 to 134 report their CQIs to the BS 100 on the allocated CQICHs, namely CQICH #1, CQICH #3, CQICH #4, num CQICH-2, and num CQICH, respectively.

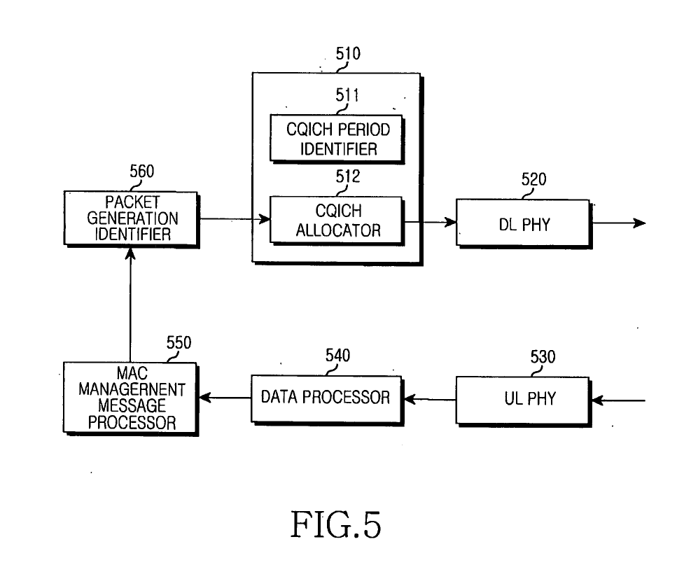

num CQICH denotes the total number of CQICHs. A CQICH controller 110 (denoted by reference numeral 510 in FIG. 5) updates CQIs and allocates and releases CQICHs to and from MSs in each frame. The CQICH controller 110 classifies MSs into a Gold group 111, a Silver group 112 and a Bronze group 113, giving priority to MSs to which CQICHs have been allocated. The classification may be based on a criterion dependent on the situation in which the BS is placed. The BS may place an MS with a high probability to receive data from the BS in a high-priority group so that the MS can report its CQI on a CIQCH for a long term even in the absence of data to be sent to the MS, relative to MSs in a low-priority group and thus the BS acquires an accurate CQI from the MS for use in actual data transmission to the MS.

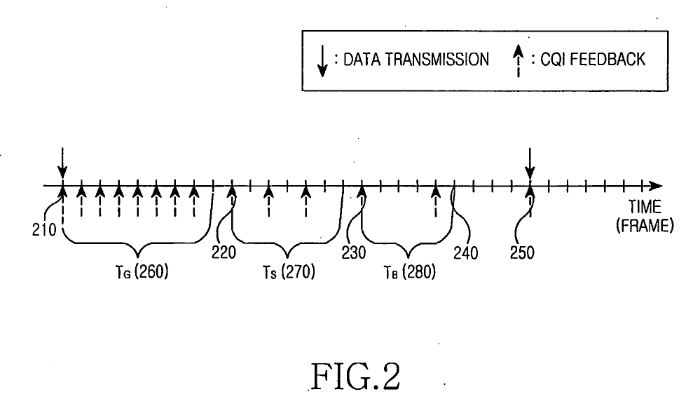

FIG. 2 illustrates a process of allocating a CQICH to an MS and releasing the CQICH from the MS by the BS on a time axis according to the present invention.

Referring to FIG. 2, if an MS, which has been kept inactive in CQI feedback without an allocated CQICH, is allocated a CQICH at time 210, the MS is classified under the Gold group and the CQICH lasts for a time period 260, T_{G}. If no data is created for the MS for T_{G} in the BS, the MS is dropped to the Silver group and reallocated a CQICH at time 220, which lasts for a time period 270, T_{S}. If no data is created for the MS either T_{S} frames later, the MS is further dropped to the Bronze group and reallocated a CQICH at time 230, which lasts for a time period 280, T_{B}. If no data is created for the MS any more for T_{B}, the CQICH is automatically released at time 240. The CQICH allocation periods T_{G}, T_{S} and T_{B} are preset for the respective groups. Later, upon generation of transmission data for the MS, a CQICH is allocated to the MS at time 250.

In terms of CQI report interval, MSs are also differentiated according to the groups to which they belong. For instance, MSs feed back their CQIs every frame in the Gold group, every two frames in the Silver group and every four frames in the Bronze group.

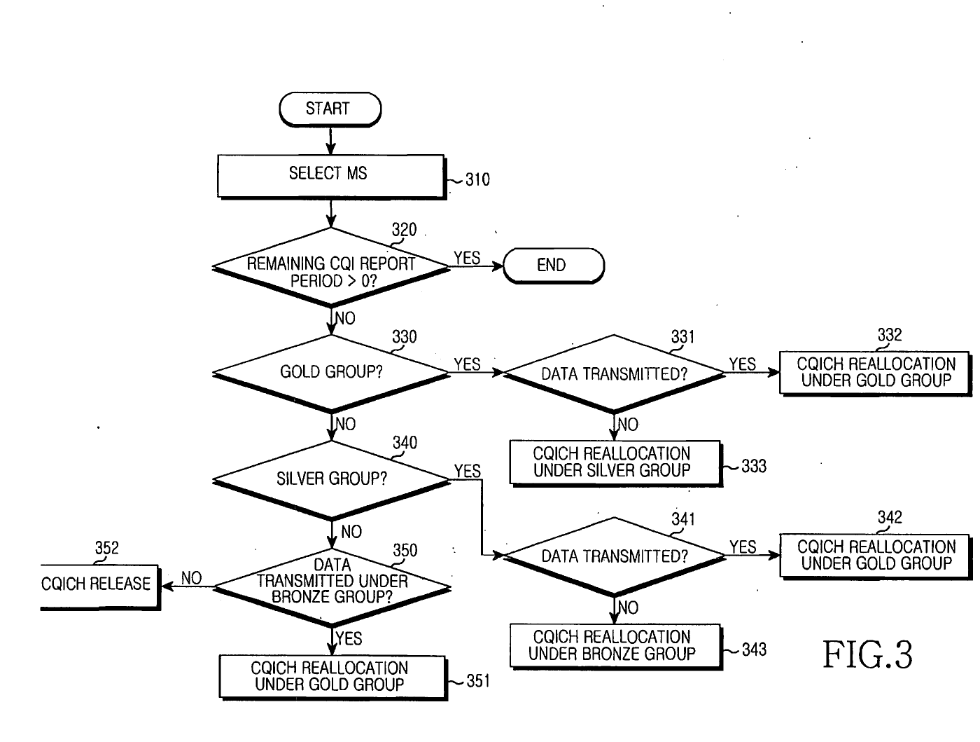

FIG. 3 is a flowchart illustrating a CQICH management operation for reallocating or releasing a CQICH when the remaining CQICH allocation period of an MS is 0.

Referring to FIG. 3, the BS sequentially selects MSs that occupy CQICHs #1 to num CQICH within its cell coverage in step 310. The CQICH controller 110 of the BS checks the remaining CQICH allocation period of the selected MS in step 320. If the remaining CQICH allocation period is greater than 0, which implies that a CQICH allocated to the MS still lasts, this procedure ends for the MS. If the remaining CQICH allocation period is 0, which implies that the CQICH allocation period of the MS has expired, the CQICH controller 110 determines whether to reallocate or release a CQICH to or from the MS. With regard to CQICH reallocation or release, a different determination is made according to the group of the MS. The CQICH controller 110 determines whether the MS is under the Gold group in step 330. In the case of the Gold group, a packet generation identifier 560 illustrated in FIG. 5 determines whether data transmission from the BS to the MS has occurred (or vice versa) during the time period T_{G} previous to a reallocation time in step 331. In the absence of any data transmission, the CQICH controller 110 reallocates a CQICH to the MS, while dropping the MS to the Silver group so that the MS operates according to the CQI report interval and the CQICH allocation period T_{S} preset for the Silver group in step 333. On the contrary, in the presence of any data transmission for T_{G}, the CQICH controller 110 keeps the MS in the Gold group, so that the CQICH allocation of the MS is lengthened by another T_{G} and the MS reports its CQI every interval preset for the Gold group, in step 332.

If the MS is in any other group than the Gold group, the CQICH controller 110 determines whether the MS is under the Silver group in step 340. In the case of the Silver group, the packet generation identifier determines whether data transmission has occurred during the time period T_{S} previous to the reallocation time in step 341. In the absence of any data transmission, the CQICH controller 110 reallocates a CQICH to the MS, while dropping the MS to the Bronze group so that the MS operates according to the CQI report interval and the CQICH allocation period T_{B} preset for the Bronze group in step 343. On the contrary, in the presence of any data transmission for T_{S}, the CQICH controller 110 promotes the MS to the Gold group, such that the CQICH allocation is lengthened for the MS by T_{G} and the MS reports its CQI every interval preset for the Gold group, in step 342. It can be further contemplated that the MS is reallocated a CQICH, still kept under the Silver group in step 342.

If the MS is not under the Silver group, which implies that the MS is under the Bronze group, the packet generation identifier determines whether data transmission has occurred during the time period T_{B} previous to the reallocation time in step 350. In the absence of any data transmission, the CQICH controller 110 releases the CQICH from the MS in step 352. On the contrary, in the presence of any data transmission for T_{B}, the CQICH controller 110 promotes the MS to the Gold group, such that the CQICH allocation is lengthened for the MS by T_{G} and the MS reports its CQI every interval preset for the Gold group, in step 351. It can be further contemplated that the MS is reallocated a CQICH, still kept under the Bronze group in step 351.

If the total number of CQICHs is num CQICH, the above operation occurs (num CQICH) times.

As described above, upon expiration of the CQICH allocation period of an MS, the CQICH allocation is extended (i.e. CQICH reallocation) by classifying the MS under the Gold group or dropping the MS to a one-level lower group depending on the presence or absence of traffic generation for the MS for a number of frames, rather than the CQICH allocated to the MS being immediately released. The MS feeds back a CQI during the CQICH allocation period preset for the group to which the MS now belongs. In this manner, an MS for which traffic is frequently created continues its CQI report, to thereby enable the BS to acquire an accurate CQI for use in actual traffic transmission to the MS.

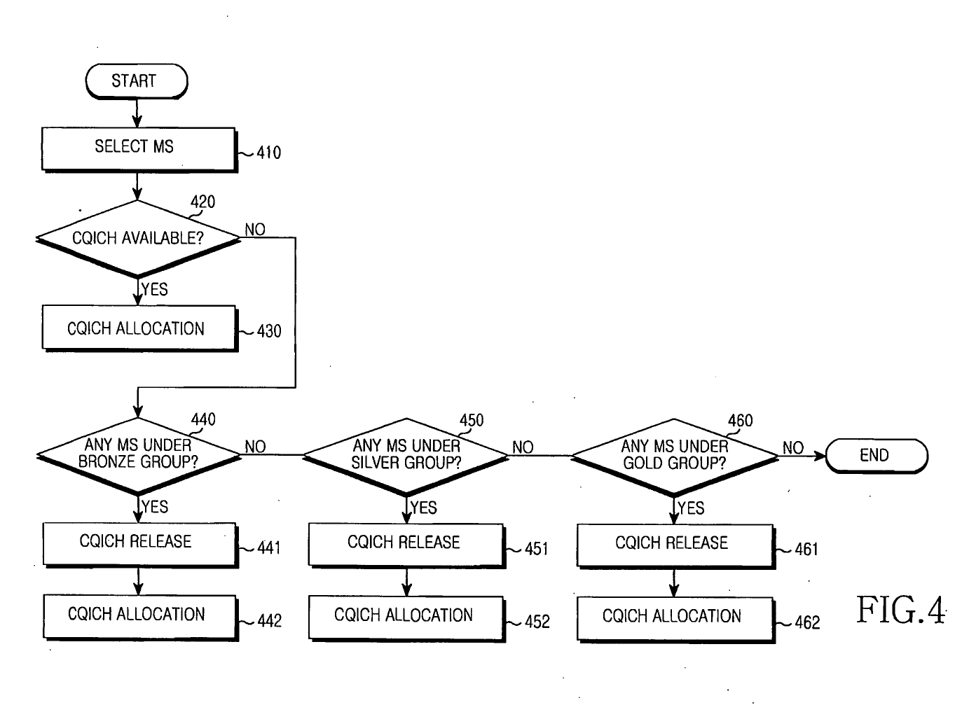

FIG. 4 is a flowchart illustrating an operation for allocating a CQICH to a new MS. The CQICH allocation operation is performed to allocate a CQICH to a new MS for data transmission, to which a CQICH was not available because all available CQICHs have been allocated to other MSs within the cell of the BS.

The CQICH allocation operation is also performed for an MS that sends uplink data to the BS but has not been allocated a CQICH, or for an MS that sends a control signal for uplink data transmission to the BS but has not been allocated a CQICH. There is a high probability that uplink data transmission or generation of a control signal for uplink data transmission is accompanied by upcoming downlink data transmission. With prior knowledge of a CQI received from the MS on a CQICH allocated in this CQICH allocation procedure, the BS can determine an optimum modulation and coding scheme for the MS.

Referring to FIG. 4, the BS select a new MS to which a CQICH is to be allocated in step 410. The CQICH controller of the BS determines whether there remains any available CQICH in step 420. In the presence of any available CQICH, the CQICH controller allocates the CQICH to the new MS and classifies the MS under the Gold group in step 430. In the absence of any available CQICH, the CQICH controller determines whether any MS under the Bronze group occupies a CQICH in step 440. The Bronze group is monitored primarily because it is the lowest-priority group and an MS using a CQICH under the Bronze group takes priority of CQICH release. In the presence of any MS occupying a CQICH under the Bronze group, the CQICH controller releases the CIQCH from the MS in step 441. If a plurality of MSs occupy CQICHs in the Bronze group, one of the MSs is selected for CQICH release according to a criterion.

The released CQICH is allocated to the new MS and the new MS is classified under the Gold group in step 442. In the absence of any MS under the Bronze group, the CQICH controller determines whether there is any MS occupying a CQICH under the Silver group in step 450. In the presence of any MS occupying a CQICH under the Silver group, the CQICH controller 410 releases the CIQCH from the MS in step 451. If a plurality of MSs occupy CQICHs in the Silver group, one of the MSs is selected for CQICH release according to a criterion. The released CQICH is allocated to the new MS and the new MS is classified under the Gold group in step 452. In the absence of any MS under the Silver group, the CQICH controller determines whether any MS under the Gold group occupies a CQICH in step 460. In the presence of any MS occupying a CQICH under the Gold group, the CQICH controller 410 releases the CIQCH from the MS in step 461. If a plurality of MSs occupy CQICHs in the Gold group, one of the MSs is selected for CQICH release according to a criterion. The released CQICH is allocated to the new MS and the new MS is classified under the Gold group in step 462. In the absence of any MS under the Gold group, the procedure ends.

Since the CQICH release starts from an MS under the lowest-priority group to which data transmission does not occur frequently, as illustrated in FIG. 4, MSs with a relatively high occurrence of data transmission can continue reporting their CQIs.

As explained above, CQICHs can be allocated in uplink data transmission based on the symmetrical nature of data transmission as well as in downlink data transmission. Hence, an accurate CQI can be acquired for use in downlink data transmission that may be occurring.

FIG. 5 is a block diagram of the BS in the wireless communication system illustrated in FIG. 1.

Referring to FIG. 5, a CQICH controller 510 includes a CQICH period identifier 511 and a CQICH allocator 512. The CQICH period identifier 511 determines whether the CQICH allocation period of an MS selected by the BS in FIG. 3 has expired. The CQICH allocator 512 is responsible for CQICH allocation, and MS grouping and degrouping. A packet generation identifier 560 determines whether downlink data packet transmission to the MS or uplink packet transmission from the MS has occurred. A DownLink (DL) PHYsical layer (DL PHY) 520 performs downlink channel coding to transmission through an antenna. An UpLink (UL) PHYsical layer (UL PHY) 530 performs uplink data reception through the antenna to channel decoding. A data processor 540 and a Medium Access Control (MAC) management message processor 550 process channel-decoded data and process MAC management messages, respectively.

In accordance with the present invention, a BS, which wirelessly communicates with many MSs on limited CQICHs, dynamically allocates and releases the CQICHs to and from the MSs. Since the BS selects optimum modulation and coding schemes for the MSs based on accurate CQIs for data transmission, the capacity of the BS increases and the efficiency of the wireless communication system is improved.

While the present invention has been shown and described with reference to certain preferred embodiments thereof, it will be understood by those skilled in the art that various changes in form and details may be made therein without departing from the spirit and scope of the invention as defined by the appended claims.

What is claimed is:

1. A method of allocating a Channel Quality Information CHannel (CQICH) in a wireless communication system, comprising:
determining whether a Mobile Station (MS) is under a first group, when a CQICH is to be allocated to the MS;
determining, if the MS is under the first group, whether any data transmission has occurred for a CQICH allocation period being preset for the first group and counted from a reallocation time; and
grouping the MS to a second group and reallocating a CQICH to the MS, the second group having a lower priority level than the first group, if no data transmission has occurred for the CQICH allocation period.

2. The method of claim 1, further comprising maintaining the MS in the first group and reallocating a CQICH to the MS, if any data transmission has occurred for the first CQICH allocation period.

3. The method of claim 1, wherein the first group and the second group have different CQICH allocation periods and different Channel Quality Information (CQI) report intervals.

4. The method of claim 1, wherein the method is performed as many times as the maximum number of CQICHs.

5. A method of allocating a Channel Quality Information CHannel (CQICH) in a wireless communication system, comprising:
determining whether a Mobile Station (MS) is under a first group, when a CQICH is to be allocated to the MS;
determining whether the MS is under a second group, the second group having a lower priority level than the first group, if the MS is not under the first group;
determining, if the MS is under the second group, whether any data transmission has occurred for a second CQICH allocation period preset for the second group and counted from a reallocation time; and
grouping the MS to a third group and reallocating a CQICH to the MS, the third group having a lower priority level than the second group, if no data transmission has occurred for the second CQICH allocation period.

6. The method of claim 5, further comprising grouping the MS to the first group and reallocating a CQICH to the MS, if any data transmission has occurred for the second CQICH allocation period.

7. The method of claim 5, further comprising maintaining the MS in the second group and reallocating a CQICH to the MS, if any data transmission has occurred for the second CQICH allocation period.

8. The method of claim 5, wherein the first group has a first CQICH allocation period and a first CQI report interval, the second group has the second CQICH allocation period longer than the first CQICH allocation period and a second CQI report interval shorter than the first CQI report interval, and the third group has a third CQICH allocation period longer than the second CQICH allocation period and a third CQI report interval shorter than the second CQI report interval.

9. A method of allocating a Channel Quality Information Channel (CQICH) in a wireless communication system, comprising:
determining whether a Mobile Station (MS) is under a first group, when a CQICH is to be allocated to the MS;
determining whether the MS is under a second group, the second group having a lower priority level than the first group, if the MS is not under the first group;
determining, if the MS is under the second group, whether any data transmission has occurred for a CQICH allocation period preset for the second group and counted from a reallocation time; and
releasing a CQICH from the MS, if no data transmission has occurred for the CQICH allocation period.

10. The method of claim 9, further comprising grouping the MS to the first group and reallocating a CQICH to the MS, if any data transmission has occurred for the CQICH allocation period.

11. The method of claim 9, further comprising maintaining the MS in the second group and reallocating a CQICH to the MS, if any data transmission has occurred for the CQICH allocation period.

12. The method of claim 9, wherein the first group has a longer CQICH allocation period and a shorter CQI report interval than the second group.

13. A Base Station (BS) for allocating a Channel Quality Information CHannel (CQICH) in a wireless communication system, comprising:
a CQICH controller for determining whether a Mobile Station (MS) is under a first group, when a CQICH is to be allocated to the MS, and grouping the MS to a second group and reallocating a CQICH to the MS, the second group having a lower priority level than the first group, if the MS is under the first group and no data transmission has occurred for a CQICH allocation period preset for the first group; and
a packet generation identifier for determining whether any data transmission has occurred for the CQICH allocation period, and notifying the CQICH controller of a determination result.

14. The BS of claim 13, wherein the CQICH controller maintains the MS in the first group and reallocates a CQICH to the MS, if the determination result indicates that any data transmission has occurred for the CQICH allocation period.

15. The BS of claim 13, wherein the first group and the second group have different CQICH allocation periods and different CQI report intervals.

16. A Base Station (BS) for allocating a Channel Quality Information CHannel (CQICH) in a wireless communication system, comprising:
a CQICH controller for determining whether a Mobile Station (MS) is under a first group, when a CQICH is to be allocated to the MS, determining, if the MS is not under the first group, whether the MS is under a second group, the second group having a lower priority level than the first group, and grouping the MS to a third group and reallocating a CQICH to the MS, the third group having a lower priority level than the second group, if the MS is under the second group and no data transmission has occurred for a second CQICH allocation period preset for the second group; and
a packet generation identifier for determining whether any data transmission has occurred for the second CQICH allocation period and notifying the CQICH controller of a determination result.

17. The BS of claim 16, wherein the CQICH controller maintains the MS in the second group and reallocates a CQICH to the MS, if the determination result indicates that any data transmission has occurred for the CQICH allocation period.

18. The BS of claim 16, wherein the first group has a first CQICH allocation period and a first CQI report interval, the second group has the second CQICH allocation period longer than the first CQICH allocation period and a second CQI report interval shorter than the first CQI report interval, and the third group has a third CQICH allocation period longer than the second CQICH allocation period and a third CQI report interval shorter than the second CQI report interval.

19. A Base Station (BS) for allocating a Channel Quality Information CHannel (CQICH) in a wireless communication system, comprising:
a CQICH controller for determining whether CQICH allocation is required for a Mobile Station (MS), determining whether the MS is under a first group, when CQICH allocation is required for the MS, determining, if the MS is not under the first group, whether the MS is under a second group, the second group having a lower priority level than the first group, and releasing a CQICH from the MS, if the MS is under the second group and no data transmission has occurred for a CQICH allocation period preset for the second group and counted from a reallocation time; and
a packet generation identifier for determining whether any data transmission has occurred for the CQICH allocation period and notifying the CQICH controller of a determination result.

20. The BS of claim 19, wherein the CQICH controller maintains the MS in the second group and reallocates a CQICH to the MS, if the determination result indicates any data transmission has occurred for the CQICH allocation period.

21. The BS of claim 19, wherein the first group has a longer CQICH allocation period and a shorter CQI report interval than the second group.

22. The BS of claim 19, wherein the CQICH controller determines whether CQICH allocation is required for the MS by identifying a remaining CQICH allocation period of the MS.
